(19) United States
(12) Patent Application Publication
(10) Pub. No.: US 2005/0281232 A1
(43) Pub. Date: Dec. 22, 2005

(54) Method and apparatus for reordering uplink data packets using transmission sequence numbers and time stamps in a mobile communication system

(75) Inventors: Soeng-Hun Kim, Suwon-si (KR); Gert-Jan Van Lieshout, Staines (GB); Himke Van Dervelde, Staines (GB)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/152,771

(22) Filed: Jun. 15, 2005

(30) Foreign Application Priority Data
Jun. 16, 2004 (KR) 2004-46327

(51) Int. Cl. H04B 7/216

(52) U.S. Cl. 370/335; 370/394

(57) ABSTRACT

A method and apparatus for reordering data sent from a user equipment (UE). The UE assigns transmission sequence numbers (TSNs) to medium access control (MAC)-e protocol data units (PDUs) through an enhanced uplink dedicated channel (E-DCH). A Node B assigns, to received PDUs, time stamps (TSs) indicating time points when the PDUs are received. Using the TSNs and the TSs, a radio network controller (RNC) solves a problem of PDU disorder due to hybrid automatic retransmission request (HARQ) operations and transfer delay between the Node B and the RNC, and reorders the PDUs.

### PRIORITY

This application claims the benefit under 35 U.S.C. §119(a) of an application entitled “Method and Apparatus for Reordering Uplink Data Packets Using Transmission Sequence Numbers and Time Stamps in a Mobile Communication System” filed in the Korean Intellectual Property Office on Jun. 16, 2004 and assigned Serial No. 2004-46327, the entire contents of which are hereby incorporated by reference.

### BACKGROUND OF THE INVENTION

1. Field of the Invention

The present invention generally relates to a wideband code division multiple access (WCDMA) communication system. More particularly, the present invention relates to a method and apparatus for reordering data packets of an enhanced uplink dedicated channel (E-DCH).

2. Description of the Related Art

A universal mobile telecommunication service (UMTS) system serving as the third generation mobile communication system uses wideband code division multiple access (WCDMA) based on a global system for mobile communications (GSM) serving as a European mobile communication system and general packet radio services (GPRS). The UMTS system performs packet-based transmission of text, digitized voice, video, and multimedia at data rates up to 2 megabits per second (Mbps) that offers a consistent set of services to mobile computer and phone users no matter where they are located in the world. In UMTS, a packet-switched connection using a packet protocol such as an Internet Protocol (IP) uses a virtual connection that is always available to any other end point in the network.

In uplink (UL) communication from a user equipment (UE) to a Node B, the UMTS system uses an enhanced uplink dedicated channel (E-DCH) to improve the performance of packet transmission. The E-DCH supports technologies such as adaptive modulation and coding (AMC), hybrid automatic retransmission request (HARQ), Node B scheduling, and so on to support stable high-speed data transmission.

The AMC determines modulation and coding schemes of a data channel according to the channel state between a Node-B and a UE, and improves the overall efficiency of the resources used for transmission. A combination of the modulation and coding schemes is referred to as a modulation and coding scheme (MCS). Various MCS levels can be defined by supportable modulation and coding schemes. The AMC adaptively determines an MCS level according to the channel state between a Node-B and a UE, and improves the efficiency of resources used for transmission.

The HARQ is a scheme for retransmitting a packet to compensate for an erroneous packet when an error occurs in an initially transmitted data packet. A receiver performs a soft-combining and decoding operation on an initially received data packet and a retransmitted packet. The HARQ scheme is divided into a chase combining (CC) scheme for retransmitting a packet with the same format as that of the initially transmitted data packet when an error occurs, and an incremental redundancy (IR) scheme for retransmitting a packet with a format different from that of the initially transmitted data packet when an error occurs.

According to a scheduling operation of a Node B, the Node B determines the uplink data transmission rate through an E-DCH and an upper limit of an available data transmission rate, and sends the determined data transmission rate information to a UE. The UE refers to the determined data transmission rate information, and determines a data transmission rate of the E-DCH.

The technology for obtaining relatively high processing efficiency by processing a plurality of HARQ channels in a parallel fashion when the E-DCH supports the HARQ is widely used. For an uplink packet data service using the E-DCH, multiple HARQ channels are provided between the UE serving as the transmitter and the Node B serving as the receiver. The UE transmits packet data through an arbitrary HARQ channel whenever packet data is generated. When an error occurs in the packet data, it is retransmitted through the HARQ channel.

If the Node B has not received the first packet data through the HARQ channel and has received the next packet data through another HARQ channel, the order of received packet data of the Node B is different from order of transmitted packet data of the UE. This is because the first packet data can be received after the soft-combining operation based on at least one retransmission. Accordingly, a need exists for a method for efficiently reordering packet data received from an E-DCH supporting the HARQ in transmission order.

### SUMMARY OF THE INVENTION

It is, therefore, an aspect of the present invention to provide a method and apparatus for solving a problem of packet disorder occurring in enhanced uplink dedicated channel (E-DCH) communications in a wideband code division multiple access (WCDMA) communication system.

It is another aspect of the present invention to provide a method and apparatus for reordering disordered packet data in to its original order in enhanced uplink dedicated channel (E-DCH) communications in a wideband code division multiple access (WCDMA) communication system.

The above and other aspects of the present invention can be achieved by a method for reordering uplink data packets in a mobile communication system for processing hybrid automatic retransmission requests (HARQs) in a parallel fashion through a plurality of retransmission channels, comprising the steps of

receiving data units including a plurality of higher layer data units and a transmission sequence number (TSN), respectively; adding, to the data units, time stamps (TSs) indicating time points when the data units are first received;

reordering the data units in transmission order according to the TSs, and storing the reordered data units; determining if the TSNs of the stored data units are successive, and determining if at least one unreceived data unit is present;

sequentially outputting all the stored data units if the at least one unreceived data unit is not present; and sequentially outputting data units before a first unreceived data unit among the stored data units if the at least one unreceived data unit is present.

When a data unit is unreceived, besides meaning that the data unit was not received by the intended receiving device, it can also mean that the data unit was received but not in the proper sequence with regard to the other data units that were received by the intended receiving device.

The above and other aspects of the present invention can also be achieved by a mobile communication system for processing hybrid automatic retransmission requests (HARQs) in a parallel fashion through a plurality of retransmission channels, comprising a user equipment (UE) for transmitting data packets to an uplink; a Node B, connected to the UE through a radio channel, for receiving the data packets through the radio channel; and a radio network controller (RNC) for reordering the data packets received by the Node B,wherein the UE comprises a higher layer entity for generating data units; a plurality of priority queues for separately storing the higher layer data units on a priority-by-priority basis; a tagging block for attaching transmission sequence numbers (TSNs) to the higher layer data units read from the priority queues; and a transmission entity for transmitting data units including the higher layer data units and the TSNs, and wherein the Node B comprises a reception entity for receiving the data units including the higher layer data units and the TSNs; and a TS adding block for adding, to the data units, time stamps (TSs) indicating time points when the data units are first received, and wherein the RNC comprises a reordering controller for receiving the data units including the TSs and the TSNs, reordering the data units in transmission order according to the TSs, and storing the reordered data units; reordering queues for separately storing the reordered data units on the priority-by-priority basis; and a gap detecting function (GDF) unit for determining if the TSNs of the stored data units are successive, and determining if at least one unreceived data unit is present, and controlling the reordering queues to sequentially output all the stored data units if the at least one unreceived data unit is not present, and controlling the reordering queues to sequentially output data units before a first unreceived data unit among the stored data units if the at least one unreceived data unit is present.

### BRIEF DESCRIPTION OF THE DRAWINGS

The above and other aspects and advantages of the present invention will be more clearly understood from the following detailed description taken in conjunction with the accompanying drawings, in which:

FIG. 1 illustrates uplink packet transmissions through enhanced uplink dedicated channels (E-DCHs) in a wideband code division multiple access (WCDMA) communication system to which an embodiment of the present invention is applied;

FIGS. 2A and 2B are graphs illustrating the rise over thermal (ROT) levels indicating the amounts of uplink radio resources capable of being assigned by a Node B;

FIG. 3 illustrates a conventional operation for transmitting packet data through an E-DCH;

FIG. 4 illustrates the protocol architecture of a mobile communication system for supporting an E-DCH in accordance with an embodiment of the present invention;

FIG. 5 illustrates a layer structure for transmitting packet data between a user equipment (UE) and a system using a plurality of queues in accordance with an embodiment of the present invention;

FIG. 6 illustrates a layer structure for transmitting packet data between a UE and a system in accordance with an embodiment of the present invention;

FIG. 7 illustrates an operation for reordering medium access control (MAC)-e protocol data units (PDUs) in accordance with an embodiment of the present invention;

FIG. 8 illustrates an operation for reordering MAC-e PDUs and detecting a gap in accordance with an embodiment of the present invention; and

FIG. 9 is a flow chart illustrating the operation of a reordering queue (RQ) in accordance with an embodiment of the present invention.

### DETAILED DESCRIPTION OF EXEMPLARY EMBODIMENTS

Exemplary embodiments of the present invention will now be described in more detail with reference to the accompanying drawings. In the following description, detailed descriptions of functions and configurations incorporated herein that are well known to those skilled in the art are omitted for clarity and conciseness. It is to be understood that the phraseology and terminology employed herein are for the purpose of description and should not be regarded as limiting the present invention.

Embodiments of the present invention reorders packet data received through an enhanced uplink dedicated channel (E-DCH) and detects unreceived packet data.

An E-DCH supporting a hybrid automatic retransmission request (HARQ) for an uplink packet data service in a wideband code division multiple access (WCDMA) communication system in accordance with embodiments of the present invention will now be described. In this case, a transmitter is a user equipment (UE), and a receiver is a Node B. The Node B is responsible for receiving packet data through the E-DCH. A radio network controller (RNC) reorders and analyzes packet data received through the E-DCH.

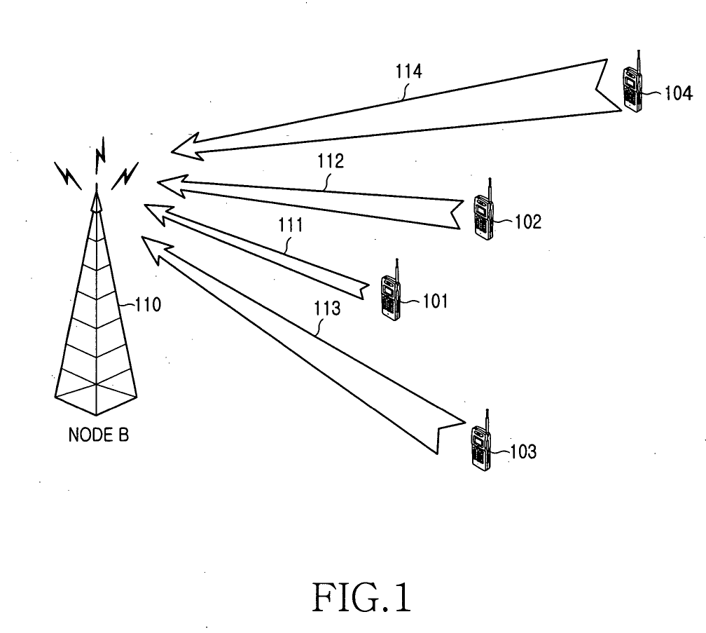

FIG. 1 illustrates uplink packet transmissions through E-DCHs in the WCDMA communication system to which embodiments of the present invention is applied. In FIG. 1, reference numeral 110 denotes a Node B for supporting E-DCHs, and reference numerals 101, 102, 103, and 104 denote UEs using the E-DCHs. The UEs 101 to 104 transmit data to the Node B 110 through E-DCHs 111, 112, 113, and 114, respectively.

Using the data buffer status, the requested data rate, or the channel status information of the UEs 101 to 104, the Node B 110 provides each UE with information indicating if E-DCH data transmission is possible, or transmission rate information for controlling an E-DCH data rate. To improve the overall performance of the system, a scheduling operation assigns relatively low data rates to the UEs 103 and 104 far away from the Node B 110 such that a noise rise value measured by the Node B 110 does not exceed a target value. However, the scheduling operation assigns relatively high data rates to the UEs 101 and 102 close to the Node B 110. The UEs 101 to 104 determine a maximum allowable data transmission rate for an E-DCH according to the transmission rate information and transmit the E-DCH data at the determined data transmission rate.

Because synchronization is not maintained between uplink signals transmitted by different UEs and the uplink signals are not orthogonal to each other, the signals interfere with each other. When the number of uplink signals received by the Node B is large, there is a problem in that amount of interference with an uplink signal of a specific UE increases and thus reception performance is degraded. To overcome this problem, the uplink link transmission power of the specific UE can be increased. However, because the increased transmission power may serve as interference to other uplink signals, the reception performance of other uplink signals is degraded. Accordingly, the Node B limits the total power of the uplink signals capable of being received by the Node B such that the reception performance can be ensured. A rise over thermal (ROT) level indicates uplink radio resources used by the Node B. The ROT level is defined as shown in Equation (1).
ROT=I₀/N₀ Equation (1)

In Equation (1), I₀ denotes a total power amount of all uplink signals received by the Node B as a power spectral density in a total reception band of the Node B, and N₀ denotes a thermal noise power spectral density at the Node B. Accordingly, a maximum allowable ROT level indicates all radio resources capable of being used in the uplink.

The total ROT level at the Node B indicates a sum of inter-cell interference, voice traffic and E-DCH traffic. Because the scheduling operation of the Node B can prevent all UEs from simultaneously transmitting packets at a high data rate, a reception ROT level is maintained to a target ROT level such that the reception performance can be ensured. That is, when the scheduling operation of the Node B allows a specific UE to transmit data at a high rate, it does not allow other UEs to transmit data at a high rate. Accordingly, the Node B can prevent the reception ROT level from exceeding the target ROT level.

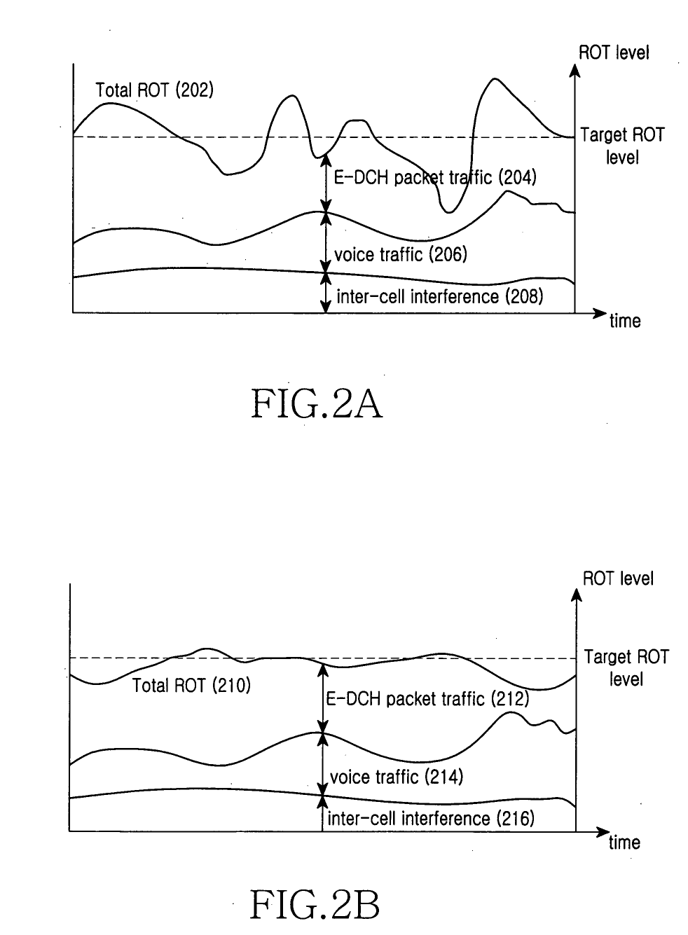

FIGS. 2A and 2B illustrate ROT levels indicating uplink resource amounts capable of being assigned by the Node B. As illustrated in FIG. 2A, the total ROT 202, indicating uplink radio resources capable of being assigned by the Node B, indicates a sum of inter-cell interference (ICI) 208, voice traffic 206, and E-DCH packet traffic 204. As illustrated in FIG. 2B, the total ROT 210 indicates a sum of ICI 216, voice traffic 214, and E-DCH packet traffic 212.

FIG. 2A illustrates the variation of the total ROT 202 when the Node B scheduling is not used. Because the scheduling operation on E-DCHs is not used, the total ROT 202 may exceed the target ROT when multiple UEs simultaneously transmit data packets at a high data rate. In this case, the performance of receiving uplink signals is seriously degraded.

FIG. 2B illustrates the variation of the total ROT 210 when the Node B scheduling is used. Because the scheduling operation on E-DCHs is used, the Node B can prevent multiple UEs from simultaneously transmitting packets at a high data rate. That is, when the Node B allows a specific UE to transmit data at a high rate, it does not allow other UEs to transmit data at a high rate, thereby preventing the total ROT 210 from exceeding the target ROT. Accordingly, the Node B scheduling can ensure the reception performance.

When a high data transmission rate is assigned to a specific UE, reception power from the UE to the Node B is increased and ROT associated with the UE occupies a large portion of the total ROT at the Node B. However, when a low data transmission rate is assigned to another UE, reception power from the UE with the assigned low data transmission rate to the Node B is reduced and ROT associated with the UE occupies a small portion of the total ROT at the Node B. Accordingly, the Node B schedules E-DCH packet data transmissions while considering a relation between data transmission rates and radio resources, data transmission rates requested by UEs, and so on.

Referring back to FIG. 1, the UEs 101 to 104 transmit uplink packet data at different transmission power levels according to this distance from the Node B 110. The UE 104, which is farthest away from the Node B 110, transmits packet data at the highest uplink channel transmission power, while the UE 101, which is closest to the Node B 110, transmits packet data at the lowest uplink channel transmission power. The Node B 110 assigns data transmission rates in inverse proportion to transmission power intensities of the UEs 101 to 104 through a scheduling operation, thereby maintaining the total ROT, reducing the ICI associated with other cells, and improving communication performance. That is, the Node B assigns a low data transmission rate to the UE 104 at the highest uplink channel transmission power, and assigns a high data transmission rate to the UE 101 at the lowest uplink channel transmission power.

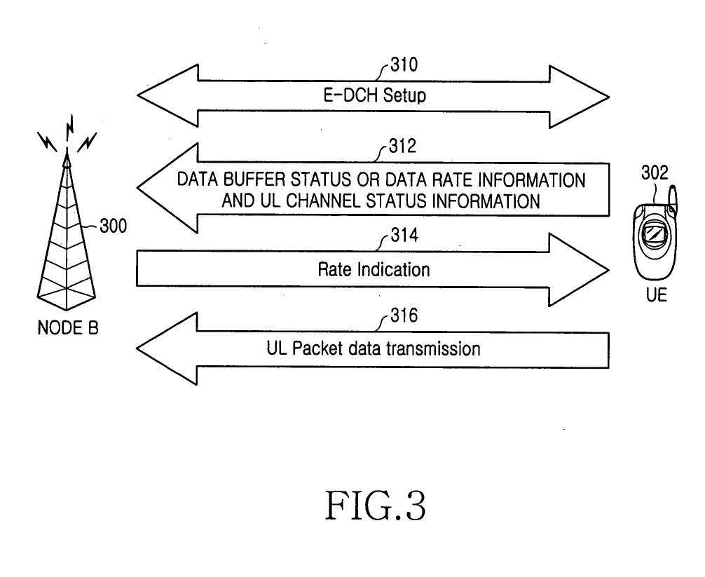

FIG. 3 illustrates an operation for transmitting packet data through an E-DCH. Referring to FIG. 3, the E-DCH is established between a Node B 300 and a UE 302 in step 310. Step 310 includes a process for transmitting and receiving messages through a dedicated transport channel (DCH). In step 312, the UE 302 reports the desired data transmission rate request information and uplink channel status information to the Node B 300. The uplink channel status information includes uplink channel transmission power information and a transmission power margin of the UE 302.

The Node B 300 compares the uplink channel transmission power with the reception power measured from a received signal from the UE 302, and estimates an uplink channel status. That is, when a difference between the uplink channel transmission power and the uplink channel reception power is small, the uplink channel status is determined to be good. However, when a difference between the uplink transmission power and the uplink channel reception power is large, the uplink channel status is determined to be bad. When the UE 302 notifies the Node B 300 of the transmission power margin such that the uplink channel status can be estimated, the Node B 300 can estimate the uplink transmission power by subtracting the transmission power margin from the known maximum transmission power of the UE 302. The Node B 300 determines the maximum allowable data transmission rate for an uplink packet channel of the UE 302 using the estimated channel status of the UE 302 and information about the data transmission rate required by the UE 302.

In step 314, the Node B 300 notifies the UE 302 of the maximum data transmission rate through transmission rate indication information. The UE 302 determines a transmission rate of packet data to be transmitted within a range of the maximum data transmission rate. In step 316, the UE 302 transmits uplink packet data at the determined data transmission rate through an E-DCH in step 316.

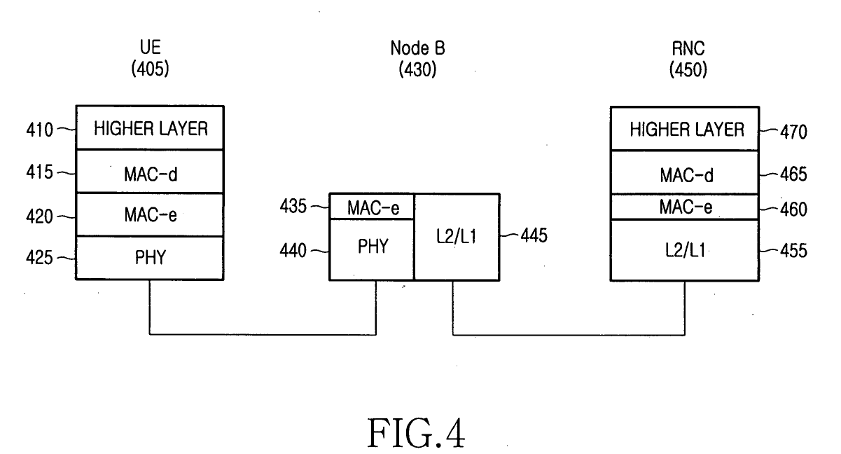

FIG. 4 illustrates the protocol architecture of a mobile communication system for supporting an E-DCH in accordance with an embodiment of the present invention. Referring to FIG. 4, a UE 405 preferably includes a physical layer 425, a medium access control (MAC)-e layer 420, a MAC-d layer 415, and a higher layer 410. The higher layer 410 preferably includes an application part for generating user data, a radio link control (RLC) layer for reconfiguring the user data to packet data with a size appropriate for radio channel transmission. The MAC-d layer 415 inserts multiplexing information into the packet data received from the higher layer 410 to generate a MAC-d protocol data unit (PDU).

The MAC-e layer 420 stores the MAC-d PDU received from the MAC-d layer 415 in a priority queue (PQ) according to a priority setting. The MAC-e layer 420 sends a queue status report and a channel quality report to a Node B 430 while considering the PQ status. When scheduling information indicating the maximum allowable transmission rate is received from the Node B 430, the MAC-e layer 420 delivers the data stored in the PQ to the physical layer 425 according to the scheduling information. In this case, the MAC-e layer 420 performs an HARQ operation while considering an acknowledgement (ACK) signal or a negative acknowledgement (NACK) signal serving as a response signal received from the Node B 430 in relation to uplink data delivered to the physical layer 425.

The physical layer 425 includes data delivered from the MAC-e layer 420 in a physical layer frame, and transmits the physical layer frame to the Node B 430 through a physical channel mapped to an E-DCH using an air interface.

The Node B 430 preferably includes a MAC-e layer 435 and a physical layer 440 as in the UE 405. The Node B 430 further includes Layer 1/Layer 2 (L1/L2) 445 for transmitting packet data to a radio network controller (RNC) 450. The physical layer 440 analyzes a radio signal sent from the physical layer 425, extracts data from the radio signal, and delivers the data to the MAC-e layer 435.

The MAC-e layer 435 delivers the data from the physical layer 440 to L2/L1 445, and performs a scheduling operation for a plurality of UEs on the basis of a queue status report and a channel quality report sent from the UE 405. The Node B 430 sends scheduling information determined through the scheduling operation and performs an HARQ operation.

The RNC 450 preferably includes a higher layer 470, a MAC-d layer 465, and a MAC-e layer 460. The RNC 450 further includes L1/L2 455 for receiving data from the Node B 430. The MAC-e layer 460 of the RNC 450 performs a complex function that is not included in the MAC-e layer 435 of the Node B 430. For example, the MAC-e layer 460 classifies packet data received from the UE 405 through the Node B 430 on a PQ-by-PQ basis and reorders data of each PQ.

The UE 405 stores, in a plurality of PQs, data to be transmitted to the E-DCH according to priorities. When a call for the E-DCH is established, the UE 405 configures the PQs within the MAC-e layer 420, and determines the number of PQs according to the number of service applications to be provided through the E-DCH. Accordingly, when the UE 405 sends the queue status report, the Node B 430 is notified of a total sum of data stored in the PQs. The Node B 430 performs a scheduling operation while considering channel statuses of UEs and priorities of data stored in the UEs.

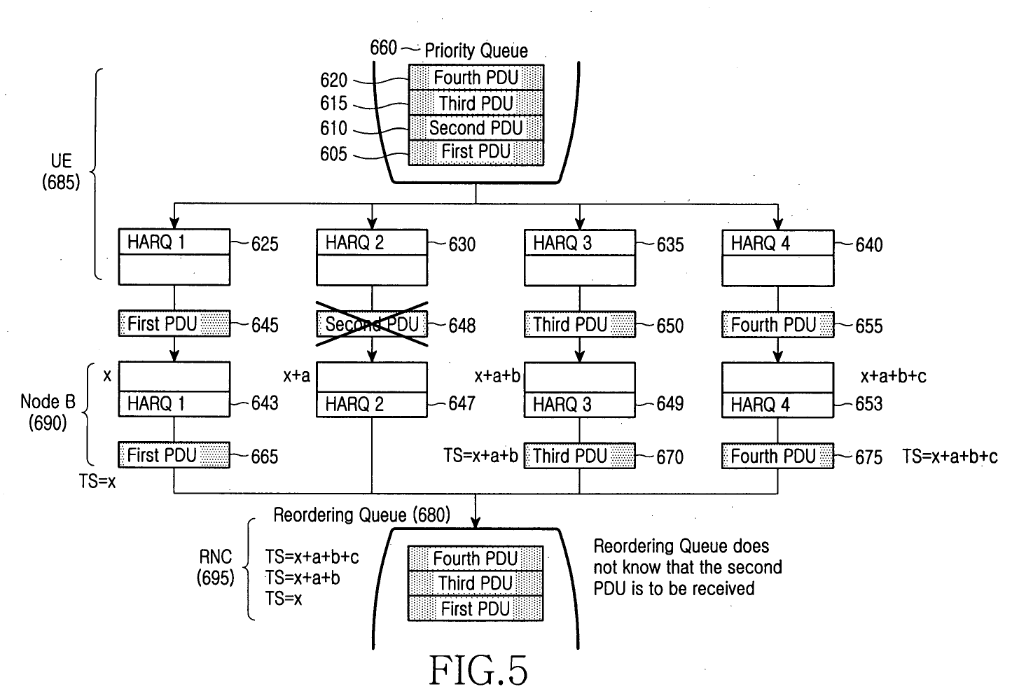

FIG. 5 illustrates a layer structure for transmitting packet data between a UE and a system using a plurality of queues in accordance with an embodiment of the present invention.

Referring to FIG. 5, a PQ 660 is preferably provided in the MAC-e layer of a UE 685 for serving the E-DCH. A reordering queue (RQ) 680 is provided in the MAC-e layer of an RNC 695. The PQ 660 stores PDUs 605, 610, 615 and 620 with the same priority before they are input to HARQ processors 625, 630, 635, and 640. The HARQ processors 625 to 640 perform an HARQ operation at the transmitting side within the UE 685. Similarly, HARQ processors 643, 647, 649, and 653 for performing an HARQ operation at the receiving side are provided in a Node B 690. The HARQ processors 625 to 640 at the transmitting side and the HARQ processors 643, 647, 649, and 653 at the receiving side are mutually coupled to HARQ channels 645, 648, 650, and 655.

The HARQ processors 625 to 640 at the transmitting side perform channel coding on the input MAC-e PDUs and transmit a result of the channel coding to a radio channel. The HARQ processors 643, 647, 649, and 653 perform channel decoding on the MAC-e PDUs received through the radio channel and determine an error occurrence through a cyclic redundancy code (CRC) computation. When it is determined that an error has not occurred, the ACK signal is sent to an HARQ processor at the transmitting side. However, when it is determined that an error has occurred, the NACK signal is sent to an HARQ processor at the transmitting side such that a MAC-e PDU retransmission request is sent. A MAC-e PDU in which an error has occurred is stored in an internal queue of an HARQ processor at the receiving side. The erroneous PDU is later combined with a retransmitted MAC-e PDU preferably according to soft combining.

In FIG. 5, a channel status is variable at a point of time when data is transmitted and received through each HARQ processor. Similarly, the requested number of retransmission times of the HARQ processors is variable at an arbitrary time point. In other words, the order of MAC-e PDUs from the UE can be changed by the HARQ processors. For example, if one MAC-e PDU has been successfully processed in one HARQ processor after four retransmissions and another MAC-e PDU has been successfully processed in another HARQ processor after two retransmissions, the order of the two MAC-e PDUs as delivered to the RNC is different from the order of the two MAC-e PDUs as sent from the UE.

When the HARQ processors 643, 647, 649, and 653 of the Node B 690 send received MAC-e PDUs to the RNC 695, the Node B sends time information of a first received MAC-e PDU, for example, a time stamp (TS), such that a disorder problem can be solved. The order of MAC-e PDUs transmitted by the UE 685 may be equal to order of MAC-e PDUs first received by the HARQ processors 643, 647, 649, and 653. The disorder problem occurs due to retransmissions of the HARQ processors 625 to 640. When the MAC-e PDUs are first received in the HARQ processors 643, 647, 649, and 653, a disorder problem does not yet occur. The TS indicates the order of MAC-e PDUs transmitted by the UE 685.

The RNC 695 reorders the MAC-e PDUs transmitted by the UE 685 using the MAC-e PDUs sent from the Node B 690 and the TSs indicating time points when the MAC-e PDUs are first received in the Node B 690. The MAC-e PDUs can be reordered according to the TSs, but a determination cannot be made as to whether an unreceived MAC-e PDU of the MAC-e PDUs is present. The Node B 690 adds a TS to a received MAC-e PDU, and sends a result of the addition to the RNC 695. When the RNC 695 performs a reordering operation on the basis of only TSs, the following problem occurs.

In FIG. 5, the PQ 660 sequentially stores first, second, third, and fourth PDUs 605, 610, 615, and 620 at arbitrary time points. The first PDU 605 is sent from HARQ Processor-1 625 to the Node B 690 through HARQ Channel-1 645. HARQ Processor-1 643 first receives the first PDU 665 at a time point x. When the first PDU 665 is successfully received through several HARQ retransmissions, HARQ Processor-1 643 adds a TS (=x) to the first PDU 665, and delivers the first PDU 665 to the RQ 680.

The UE 685 sends the second PDU 610 from HARQ Processor-2 630 to the Node B 690 through HARQ Channel-2 648. HARQ Processor-2 647 of the Node B 690 receives a second PDU with an error at a time point x+a. The second PDU is not successfully transmitted despite several HARQ retransmissions.

The UE 685 sends the third PDU 615 from HARQ Processor-3 635 to the Node B 690 through HARQ Channel-3 650. HARQ Processor-3 649 of the Node B 690 first receives the third PDU 670 at a time point x+a+b. When the third PDU 670 is successfully received through several HARQ retransmissions, HARQ Processor-3 649 adds a TS (=x+a+b) to the third PDU 670, and delivers the third PDU 670 to the RQ 680.

The UE 685 sends the fourth PDU 620 from HARQ Processor-4 640 to the Node B 690 through HARQ Channel-4 655. HARQ Processor-4 653 of the Node B 690 first receives the fourth PDU 675 at a time point x+a+b+c. When the fourth PDU 675 is successfully received through several HARQ retransmissions, HARQ Processor-4 653 adds a TS (=x+a+b+c) to the fourth PDU 675, and delivers the fourth PDU 675 to the RQ 680.

Consequently, the RQ 680 stores the first PDU 665, the third PDU 670, and the fourth PDU 675. Because TS values for the PDUs 665, 670, and 675 monotonously increase in a state in which the RQ 680 does not detect that the second PDU is to be received, the RQ 680 determines that the PDUs 665, 670, and 675 has been reordered and delivers them to a higher layer. The RQ 680 of the RNC 695 cannot determine if an unreceived PDU is present only using TSs added to the PDUs received by the Node B 690.

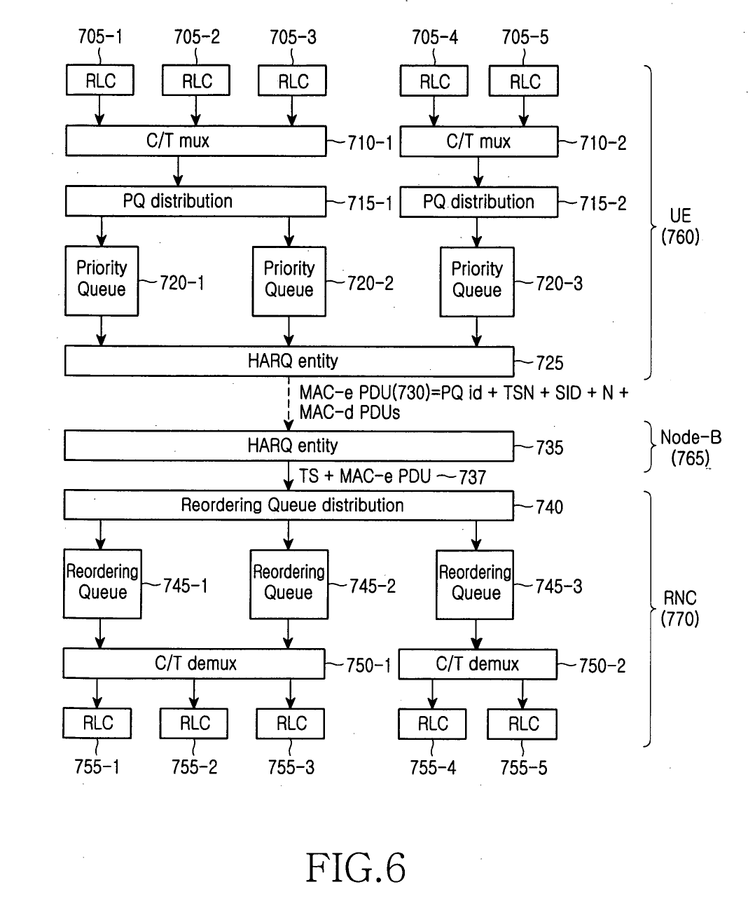

FIG. 6 illustrates a layer structure for transmitting packet data between a UE and a system in accordance with an embodiment of the present invention. The system includes the Node B and the RNC.

Referring to FIG. 6, a UE 760 preferably includes PQs 720-1, 720-2, and 720-3, and an RNC 770 preferably includes RQs 745-1, 745-2, and 745-3 mapped to the PQs 720-1, 720-2, and 720-3. The PQs 720-1 to 720-3 store data with the same priority, respectively. The RQs 745-1 to 745-3 reorder data with the same priority in transmission order, respectively.

The UE 760 also preferably includes a plurality of RLC entities 705-1, 705-2, 705-3, 705-4, and 705-5. The RLC entities 705-1 to 705-5 are connected to control/traffic (C/T) multiplexers 710-1 and 710-2. The multiplexers 710-1 and 710-2 are mapped to C/T demultiplexers 750-1 and 750-2 at the receiving side. Multiplexing fields are inserted into data received from the RLC entities 705-1 to 705-5 such that data received by the C/T demultiplexers 750-1 and 750-2 can be delivered to RLC entities 755-1, 755-2, 755-3, 755-4, and 755-5. The UE 760 preferably includes the C/T multiplexers 710-1 and 710-2. The C/T multiplexers 710-1 and 710-2 and the PQs 720-1 to 720-3 are connected through PQ distributors 715-1 and 715-2. A call setup process determines the relationship between the C/T multiplexers 710-1 and 710-2 and the PQs 720-1 to 720-3. One PQ is not connected to a plurality of multiplexers.

The PQs 720-1 to 720-3 store data from RLC entities with the same priority, respectively. The C/T multiplexers 710-1 and 710-2 insert multiplexing fields into data output from the RLC entities 705-1 to 705-5. The PQ distributors 715-1 and 715-2 refer to the multiplexing fields, and distribute input data to the PQs 720-1 to 720-3. A call setup process determines a relation between the PQs 720-1 to 720-3 and the RLC entities 705-1 to 705-5.

In the exemplary structure of FIG. 6, the three RLC entities 705-1, 705-2, and 705-3 are connected to C/T Multiplexer-i 710-1, and the two RLC entities 705-4 and 705-5 are connected to C/T Multiplexer-2 710-2. Data output from the three RLC entities 705-1, 705-2, and 705-3 is input to one of the PQs 720-1 and 720-2 according to priorities. The two RLC entities 705-4 and 705-5 with the same priority are connected to the PQ 720-3.

Data of the UE 760 is stored in the PQs 720-1 to 720-3 and is input to an HARQ entity 725. The HARQ entity 725 transmits the input data to an HARQ entity 735 according to a HARQ operation. The HARQ entities 725 and 735 are a set of HARQ processors. Data transmitted and received between the HARQ entities 725 and 735 is referred to as a MAC-e PDU 730.

The MAC-e PDU 730 preferably includes one or more MAC-d PDUs stored in the PQs 720-1 to 720-3. A header of the MAC-e PDU 730 includes a PQ identifier (ID) of the MAC-d PDUs, a transmission sequence number (TSN) to be used to reorder MAC-e PDUs, a size index (SID) indicating a size of the MAC-d PDUs, and the number of MAC-d PDUs N.

When the HARQ entity 735 of a Node B 765 successfully receives the MAC-e PDU 730, the MAC-e PDU 730 is sent to an RQ distributor 740 of the RNC 770 through an Iub interface. In this case, the HARQ entity 735 adds, to the MAC-e PDU 730, a TS indicating a time point when the MAC-e PDU 730 is first received, and sends a modified MAC-e PDU 737 to the RQ distributor 740. The RQ distributor 740 refers to a PQ ID of the MAC-e PDU 737, and distributes the MAC-e PDU 737 to a suitable RQ 745-1, 745-2, or 745-3.

The RQs 745-1 to 745-3 sequentially store a plurality of MAC-e PDUs delivered from the RQ distributor 740 according to TSs. The MAC-e PDUs are reordered on the basis of TSNs and TSs. The reordered MAC-e PDUs are divided into MAC-d PDUs. The MAC-d PDUs are delivered to the C/T demultiplexers 750-1 and 750-2. The C/T demultiplexers 750-1 and 750-2 refer to multiplexing fields of the input MAC-d PDUs, and deliver the MAC-d PDUs to the RLC entities 755-1, 755-2, 755-3, 755-4, and 755-5.

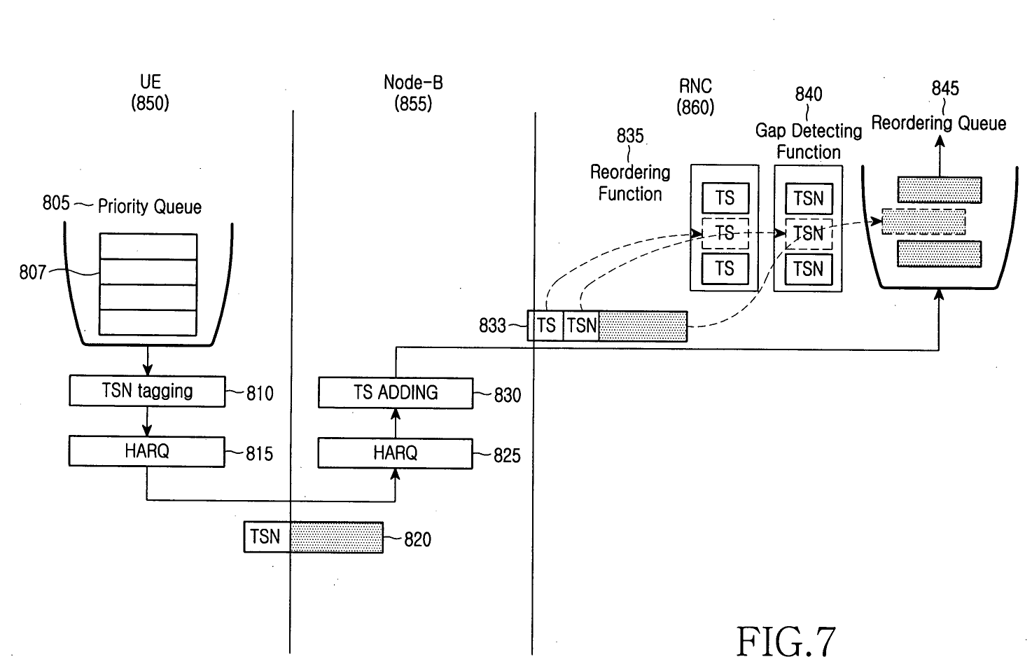

FIG. 7 illustrates an operation for reordering MAC-e PDUs in an RNC in accordance with an embodiment of the present invention.

Referring to FIG. 7, a PQ 805 of a UE 850 stores data delivered to a higher layer, such as MAC-d PDUs 807. The MAC-d PDUs 807 are combined with a TSN in a TSN tagging block 810. The MAC-d PDUs 807 are included in a MAC-e PDU 820 through an HARQ entity 815. Subsequently, the MAC-e PDU 820 is transmitted to an HARQ entity 825 of a Node B 855 through a radio channel. A TSN is managed for the PQ 805, and is a positive integer incremented by one whenever the number of MAC-e PDUs is incremented by one. The TSN cannot exceed a preset maximum value. When the TSN reaches the maximum value, it is initialized to 0.

The MAC-e PDU 820 preferably including a TSN received by the Node B 855 is input to a TS adding block 830 through an HARQ entity 825. The TS adding block 830 adds a TS to the MAC-e PDU 820, generates a modified MAC-e PDU 833, and sends the modified MAC-e PDU 833 to an RQ 845 of an RNC 860. The TS indicates a time point when the MAC-e PDU 820 is first received in the HARQ entity 825. For example, the TS may be a connection frame number (CFN) at the time point when the MAC-e PDU 820 is first received in the HARQ entity 825. The CFN is time information managed between the UE and the network, and has one integer value of 0 to 255. When a first call is established, a start value of the CFN is determined. The CFN is incremented by one every 10 msec.

In a parallel HARQ operation, a time point when the MAC-e PDU 820 is first received in the HARQ entity 825 is different from a time point when the MAC-e PDU 820 is successfully decoded and is received in the RQ 845 of the RNC 860. For example, CFN=x when the MAC-e PDU 820 is first received in the HARQ entity 825, and CFN=x+a when the MAC-e PDU 820 is delivered after several retransmissions and soft combining. In this case, the TS adding block 830 adds a TS (=x) to the MAC-e PDU 820.

In addition to the RQ 845, the RNC 860 preferably includes a reordering function unit 835 serving as a reordering controller and a gap detecting function (GDF) unit 840. The reordering controller 835 examines the TS of the MAC-e PDU 833, and stores a MAC-e PDU except for the TS in a suitable storage area of the RQ 845. In this case, the reordering controller 835 locates a MAC-e PDU with a smaller TS value, which is a MAC-e PDU received earlier in the HARQ entity 825, in a storage area close to the output port of the RQ 845. Moreover, the reordering controller 835 stores a MAC-e PDU with a larger TS value, which is a MAC-e PDU received later in the HARQ entity 825, in a storage area close to the input port of the RQ 845. The MAC-e PDUs stored in the RQ 845 are reordered and stored in TS order. For example, when the RQ 845 is a first input and first output (FIFO) memory, the earlier received MAC-e PDU is stored in an area with a relatively small address value and the later received MAC-e PDU is stored in an area with a relatively large address value.

For example, when three MAC-e PDUs are input to the RQ 845 and the TS values of the MAC-e PDUs are x, x+1, and x+2, a MAC-e PDU with the TS value of x is stored in an area close to the output port of the RQ 845 and a MAC-e PDU with the TS value of x+2 is stored in an area close to the input port of the RQ 845. A MAC-e PDU with the TS value of x+1 is stored between the MAC-e PDUs with the TS values of x and x+2. The RQ 845 first delivers, to a higher layer, a MAC-e PDU in an area close to the output port of the RQ 845 based on permission from the GDF unit 840.

The GDF unit 840 examines the TSNs of the reordered and stored MAC-e PDUs according to TSs, and determines if an unreceived MAC-e PDU is present. If an unreceived MAC-e PDU is not present, the GDF unit 840 permits the MAC-e PDUs stored in the RQ 845 to be delivered to the higher layer. Successive TSNs are attached to the MAC-e PDUs of the PQ 805 to be transmitted. Accordingly, the TSNs of the MAC-e PDUs stored in the RQ 845 must be successive. If a MAC-e PDU is retransmitted from the HARQ entity 825, an empty TSN, or a gap, is present in the RQ 845. This gap corresponds to a discontinuous TSN, and indicates that an unreceived MAC-e PDU is present.

Accordingly, the GDF unit 840 reexamines TSNs of MAC-e PDUs reordered according to TSs, and delivers, to the higher layer, the MAC-e PDUs with successive TSNs before an empty TSN. The GDF unit 840 controls the RQ 845 to store MAC-e PDUs after the empty TSN until a MAC-e PDU of the empty TSN is filled. If at least two empty TSNs are present, MAC-e PDUs before the first empty TSN are delivered to the higher layer.

It is preferred that the size of a TSN is small because a TSN is transmitted along with a MAC-e PDU. Because the TSN is used to detect a gap between the MAC-e PDUs, the TSN size can be set such that a disorder problem occurring in the HARQ entity 825 can be solved. The disorder problem occurring in the HARQ entity 825 indicates that the order of MAC-e PDUs received by the HARQ entity 825 is different from that of MAC-e PDUs delivered to the RQ 845.

The TSN size is closely associated with the number of HARQ processors provided in the UE. That is, because a disorder degree is associated with an HARQ entity size, the TSN size depends upon the number of HARQ processors included in the HARQ entity. For example, when the number of HARQ processors is three, TSNs have three higher layer serial numbers of 0 to 2.

When the TSN is one of n values of 0˜n-1, or, in other words, when the number of TSNs is less than the number of HARQ processors, gap detection fails in the following states.

a1. The HARQ entity at the receiving side successfully receives a MAC-e PDU with a TSN of x, and sends the received MAC-e PDU to the RQ.

a2. The HARQ entity at the receiving side fails to receive all n PDUs including a MAC-e PDU with the TSN of x+1 and a MAC-e PDU with the TSN of x, and a retransmission operation is performed.

a3. The HARQ entity at the receiving side successfully receives a MAC-e PDU with the TSN of x+1, and sends the received MAC-e PDU to the RQ.

a4. The RQ receives MAC-e PDUs with two successive TSNs when a TS value is incremented, and stored MAC-e PDUs are sent to a higher layer in a state in which the RQ does not know that all n PDUs have not been received.

When the number of HARQ processors is n, a gap does not occur if HARQ operations for the n MAC-e PDUs are simultaneously performed and a new MAC-e PDU is successfully received. In other words, when a TSN size is set to be greater than or equal to the number of HARQ processors, gap detection does not fail. An example in which the number of HARQ processors is 3 and a TSN is in the range of 0˜2 will be described. Here, MAC-e PDU (x) indicates a MAC-e PDU with a TSN of x.

b1. After MAC-e PDU (0) is received in HARQ Processor 0, it successfully delivers MAC-e PDU (0) to the RQ.

b2. After MAC-e PDUs (1) and (2) are received in HARQ Processors 1 and 2, respectively, they are present in a retransmission process.

b3. After MAC-e PDU (0) is received in HARQ Processor 0, it is present in a retransmission process.

Because no available HARQ processor is present even though new MAC-e PDU (1) is generated in the above-described case, the new MAC-e PDU (1) can be processed after the previous MAC-e PDU (1) is successfully transmitted and received. Accordingly, an error cannot occur in a reordering operation. The TSN has information size that can express an HARQ entity size,in other words, the number of HARQ processors included in the HARQ entity. The TSN size is computed as shown in Equation (2).
TSN size=Ceiling (1, log₂NO_{—HARQ)} Equation (2)

In Equation (2), Ceiling (1, x) is a ceiling function for finding the smallest integer not less than x. For example, Ceiling (1, 1.001)=2.

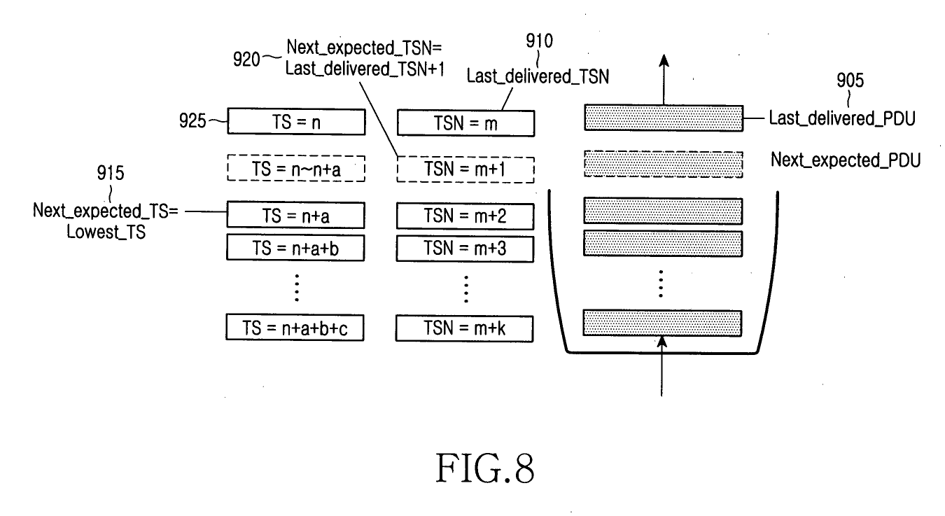

Next, an operation in which the RQ reorders MAC-e PDUs and detects a gap using TSs and TSNs will be described in more detail with reference to FIG. 8. The reordering operation on the MAC-e PDUs uses a parameter Next_expected_TS, and the gap detecting operation uses a parameter Next_expected_TSN.

In FIG. 8, multiple MAC-e PDUs are stored in an RQ of an RNC at an arbitrary time point X, the last MAC-e PDU delivered to a higher layer is referred to as a Last_delivered_PDU 905, and a TSN of the Last_delivered_PDU 905 is referred to as a Last_delivered_TSN 910. The Next_expected_TSN 920 representing the next TSN expected at the time point X is a value obtained by adding one to the Last_delivered_TSN. That is, Next_expected_TSN=Last_delivered_TSN+1. The Next_expected_TS 915 is set to the lowest TS value, which is represented by the variable Lowest_TS, among the TSs of the MAC-e PDUs stored in the PQ of the UE.

Upon receiving one MAC-e PDU, the RQ determines if a TS and TSN of the received MAC-e PDU satisfy the following conditions.

c1. The TS of the received MAC-e PDU is present between a TS 925 (for example, n in FIG. 8) of the last MAC-e PDU delivered to a higher layer and the lowest TS (for example, n+a in FIG. 8) of TSs of MAC-e PDUs stored in the RQ.

c2. The TSN of the received MAC-e PDU is 1 larger than that of the last MAC-e PDU delivered to the higher layer, which is represented by the Last_delivered_TSN 910. In other words, the TSN of the received MAC-e PDU is equal to the Next_expected_TSN 920.

If the above-described conditions are satisfied, the received MAC-e PDU is used to fill a gap present in the RQ. The RQ delivers, to the higher layer, the received MAC-e PDU and all MAC-e PDUs before the next gap. However, if the above-described conditions are not satisfied, the received MAC-e PDU does not fill the gap present in the RQ. In this case, the received MAC-e PDU is stored in an area indicated by its TS. The RQ waits for the next MAC-e PDU to be received.

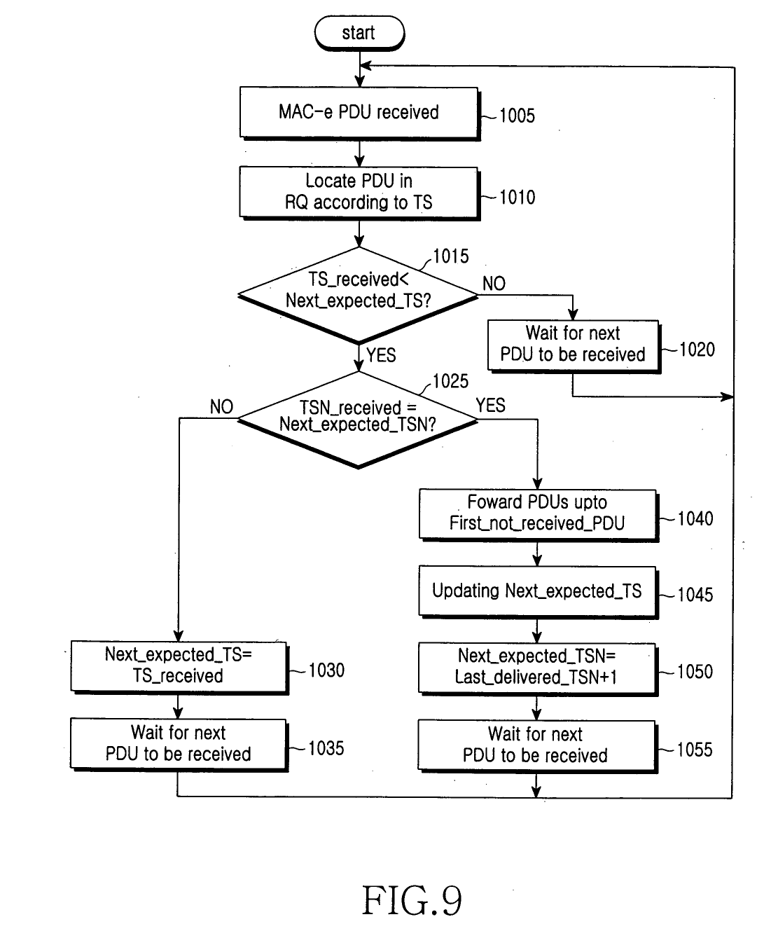

FIG. 9 is a flow chart illustrating the operation of the RQ in accordance with an embodiment of the present invention.

Referring to FIG. 9, the RNC receives a MAC-e PDU including a TSN and a TS in step 1005. The RNC stores the received MAC-e PDU in an area of the RQ according to the TS in step 1010. As described above, the RNC stores the received MAC-e PDUs in descending order of TS values. That is, the RNC stores a MAC-e PDU in a storage area closer to the input port of the RNC when a TS value of the PDU is larger.

In step 1015, the RNC determines if TS_received representing the TS value of the MAC-e PDU is less than Next_expected_TS representing the next TS value. If TS_received is less than Next_expected_TS, the RNC proceeds to step 1025. However, if TS_received is greater than or equal to Next_expected_TS, the RNC proceeds to step 1020. When the RQ is empty before the MAC-e PDU is received, the condition of TS_received<Next_expected_TS in step 1015 is always true.

In step 1020, the RNC determines that the MAC-e PDU is not Next_expected_PDU, and waits for the next PDU to be received.

In step 1025, the RNC determines if TSN_received representing the TSN of the MAC-e PDU is equal to Next_expected_TSN such that a determination can be made as to whether the MAC-e PDU is Next_expected_PDU. If TSN_received is equal to Next_expected_TSN, the RNC proceeds to step 1040 because the MAC-e PDU is Next_expected_PDU. However, if TSN_received is not equal to Next_expected_TSN, the RNC proceeds to step 1030 because the MAC-e PDU is not the Next_expected_PDU. The RNC updates Next_expected_TS to TS_received in step 1030, and then proceeds to step 1035. The RNC waits for the next PDU to be received in step 1035, and then returns to step 1005.

In step 1040, the RNC identifies the first gap after Next_expected_PDU, which is the First_not_received_PDU representing the first unreceived PDU. In other words, when gaps are present between TSNs of MAC-e PDUs stored in the RQ, a PDU closest to the output port of the RQ among the gaps becomes the First_not_received_PDU. Then, the RNC delivers, to the higher layer, PDUs between First_not_received_PDU and Next_expected_PDU.

In step 1045, the RNC updates Next_expected_TS to the lowest TS value of the TSs of the MAC-e PDUs stored in the RQ. In step 1050, the RNC updates Next_expected_TSN to a value obtained by adding one to a TSN of Last_delivered_PDU representing the last MAC-e PDU delivered to the higher layer, which is the Last_delivered_TSN. If multiple PDUs have been delivered to the higher layer in step 1040, the last MAC-e PDU of the delivered PDUs becomes the Last_delivered_PDU. The RNC waits for the next PDU to be received in step 1055, and then returns to step 1005.

For example, the following MAC-e PDUs are stored in the RQ at an arbitrary time point X. At the time point X, Next_expected_TSN=1 and TSN_size=2 bits. In the following, MAC-e PDU (x, y) indicates a MAC-e PDU in which a TS and a TSN are x and y, respectively.

MAC-e PDU (10, 2)

MAC-e PDU (12, 3)

MAC-e PDU (13, 0)

MAC-e PDU (15, 1)

MAC-e PDU (18, 3)

MAC-e PDU (19, 0)

When MAC-e PDU (8, 1) is received in the RQ, TS_received (=8) is less than Next_expected_TS (=10) and TSN_received (=1) is equal to Next_expected_TSN (=1). Accordingly, it is determined that MAC-e PDU (8, 1) is the Next_expected_PDU.

A gap between the TSN values is present between MAC-e PDU (15, 1) and MAC-e PDU (18, 3). First_not_received_PDU is a PDU in which the TS is a value between 15 and 18, and the TSN is 2. Accordingly, the RQ delivers MAC-e PDU (8, 1), MAC-e PDU (10, 2), MAC-e PDU (12, 3), MAC-e PDU (13, 0), and MAC-e PDU (15, 1) to the higher layer. The RNC updates Next_expected_TS to 18, and updates Next_expected_TSN to 2. The RNC waits for the next PDU to be received.

As is apparent from the above description, the embodiments of the present invention have a number of advantages.

In accordance with embodiments of the present invention, the transmission sequence numbers (TSNs) are attached to packet data units to be transmitted, time stamps (TSs) are added to the received data units, and the data units are reordered to original order using the TSNs and the TSs. Therefore, embodiments of the present invention can minimize the inefficient use of enhanced uplink dedicated channels (E-DCHs) supporting a hybrid automatic retransmission request (HARQ). Moreover, embodiments of the present invention can efficiently solve a problem of data disorder occurring in a higher layer due to packet data retransmissions.

Although exemplary embodiments of the present invention have been disclosed for illustrative purposes, those skilled in the art will appreciate that various modifications, additions, and substitutions are possible, without departing from the scope of the present invention. Therefore, the present invention is not limited to the above-described embodiments, but is defined by the following claims, along with their full scope of equivalents.

1. A method for reordering uplink data packets in a mobile communication system, comprising the steps of:
receiving data units comprising a plurality of higher layer data units and a transmission sequence number (TSN), respectively;
adding, to the data units, time stamps (TSs) indicating time points when the data units are first received;
reordering the data units in transmission order according to the TSs, and storing the reordered data units;
determining if the TSNs of the stored data units are successive, and determining if at least one unreceived data unit is present;
sequentially outputting all the stored data units if the at least one unreceived data unit is not present; and
sequentially outputting data units before a first unreceived data unit among the stored data units if the at least one unreceived data unit is present.

2. The method of claim 1, wherein the adding step comprises the step of:
adding, to the data units, the TSs indicating the time points when the data units are first received before the data units are combined with data units retransmitted through an HARQ process according to soft combining.

3. The method of claim 1, wherein the TSs indicate connection frame numbers (CFNs) based on the time points when the data units are first received in a Node B.

4. The method of claim 1, wherein the storing step comprising the steps of:
locating a data unit with a relatively low TS value in a storage area close to an output port; and
locating a data unit with a relatively high TS value in a storage area close to an input port.

5. The method of claim 1, wherein the TSN has a maximum value equal to the number of retransmission channels.

6. The method of claim 1, wherein the step of determining if at least one unreceived data unit is present comprises the steps of:
determining if a TS value of one data unit of the received data units is less than a next expected TS value;
determining if a TSN of the received data unit is equal to a next expected TSN if the TS value of the received data unit is less than a next expected TS value;
setting the next expected TS value to the TS value of the received data unit if the TSN of the received data unit is not equal to the next expected TSN; and
determining that the at least one unreceived data unit is present if the TSN of the received data unit is equal to the next expected TSN.

7. The method of claim 6, further comprising the steps of:
if the TSN of the received data unit is equal to the next expected TSN, updating the next expected TS value to a lowest value of TS values of the stored data units; and
updating the next expected TSN to a value obtained by adding one to a TSN of a last output data unit.

8. A mobile communication system, comprising:
a user equipment (UE) for transmitting data packets to an uplink;
a Node B, connected to the UE through a radio channel, for receiving the data packets through the radio channel; and
a radio network controller (RNC) for reordering the data packets received by the Node B,
wherein the UE comprises:
a higher layer entity for generating data units;
a plurality of priority queues for separately storing the higher layer data units on a priority-by-priority basis;
a tagging block for attaching transmission sequence numbers (TSNs) to the higher layer data units read from the priority queues; and
a transmission entity for transmitting data units including the higher layer data units and the TSNs, and
wherein the Node B comprises:
a reception entity for receiving the data units including the higher layer data units and the TSNs; and
a TS adding block for adding, to the data units, time stamps (TSs) indicating time points when the data units are first received, and
wherein the RNC comprises:
a reordering controller for receiving the data units including the TSs and the TSNs, reordering the data units in transmission order according to the TSs, and storing the reordered data units;
reordering queues for separately storing the reordered data units on the priority-by-priority basis; and
a gap detecting function (GDF) unit for determining if the TSNs of the stored data units are successive, and determining if at least one unreceived data unit is present, and controlling the reordering queues to sequentially output all the stored data units if the at least one unreceived data unit is not present, and controlling the reordering queues to sequentially output data units before a first unreceived data unit among the stored data units if the at least one unreceived data unit is present.

9. The mobile communication system of claim 8, wherein the TS adding block adds, to the data units, the TSs indicating the time points when the data units are first received before the data units are combined with data units retransmitted through an HARQ process according to soft combining.

10. The mobile communication system of claim 8, wherein the TSs indicate connection frame numbers (CFNs) based on the time points when the data units are first received in the Node B.

11. The mobile communication system of claim 8, wherein a data unit with a relatively low TS value is located in a storage area close to an output port of the reordering queues, and wherein a data unit with a relatively high TS value is located in a storage area close to an input port of the reordering queues.

12. The mobile communication system of claim 8, wherein the TSN has a maximum value equal to the number of retransmission channels.

13. The mobile communication system of claim 8, wherein the GDF unit updates a next expected TS value to a TS value of one data unit of the received data units if the TS value of the received data unit is less than the next expected TS value and a TSN of the received data unit is not equal to a next expected TSN, and
wherein the GDF unit determines that the at least one unreceived data unit is present if the TS value of the received data unit is less than the next expected TS value and the TSN of the received data unit is equal to the next expected TSN.

14. The mobile communication system of claim 13, wherein the GDF unit updates the next expected TS value to a lowest value of TS values of the stored data units and updates the next expected TSN to a value obtained by adding one to a TSN of a last output data unit, if the TS value of the received data unit is less than the next expected TS value and the TSN of the received data unit is equal to the next expected TSN.

15. A method for reordering uplink data in a mobile communication system, comprising the steps of:
receiving a protocol data unit (PDU) of an enhanced uplink dedicated channel (E-DCH) including a transmission sequence number (TSN) and a time stamp (TS), the TS indicating a time point when the PDU is first received;
storing the received PDU according to the TS;
determining if a value of the TS is less than a next expected TS;
determining if the TSN is equal to a next expected TSN if the TS value is less than the next expected TS; and
outputting PDUs before a first unreceived PDU among stored PDUs if the TSN is equal to the next expected TSN.

16. The method of claim 15, further comprising the steps of:
if the TSN is not equal to the next expected TSN, updating the next expected TS to the TS of the received PDU.

17. The method of claim 16, further comprising the steps of:
after the PDUs are output, updating the next expected TS value to a lowest value of TS values of the stored PDUs; and
updating the next expected TSN to a value obtained by adding one to a TSN of a last output PDU.

18. The method of claim 17, wherein the TS indicates the time point when the PDU is first received before the PDU is combined with at least one PDU retransmitted through an HARQ process according to soft combining.

19. The method of claim 18, wherein the TS indicates a connection frame number (CFN) based on the time point when the PDU is first received in a Node B.

20. The method of claim 17, wherein the TSN has a maximum value equal to the number of retransmission channels.

21. A radio network controller (RNC) for reordering uplink data in a mobile communication system, comprising:
a reordering controller for receiving a protocol data unit (PDU) of an enhanced uplink dedicated channel (E-DCH) including a transmission sequence number (TSN) and a time stamp (TS) and identifying the TS from the PDU;
a reordering queue for storing the received PDU according to the TS; and
a gap detecting function (GDF) unit for controlling the reordering queue to output PDUs before a first unreceived PDU among stored PDUs if a value of the TS is less than a next expected TS and the TSN is equal to a next expected TSN.

22. The RNC of claim 21, wherein the GDF unit updates the next expected TS to the TS of the received PDU if the TS value is less than the next expected TS and the TSN is not equal to the next expected TSN.

23. The RNC of claim 22, wherein the GDF unit updates the next expected TS value to a lowest value of TS values of the stored PDUs and updates the next expected TSN to a value obtained by adding one to a TSN of a last output PDU, after the PDUs are output.

24. The RNC of claim 23, wherein the TS indicates the time point when the PDU is first received before the PDU is combined with at least one PDU retransmitted through an HARQ process according to soft combining.

25. The RNC of claim 24, wherein the TS indicates a connection frame number (CFN) based on the time point when the PDU is first received in a Node B.

26. The RNC of claim 23, wherein the TSN has a maximum value equal to the number of retransmission channels.
